(19) United States
(12) Patent Application Publication
(10) Pub. No.: US 2020/0262403 A1
(43) Pub. Date: Aug. 20, 2020

(54) SYSTEM AND METHOD FOR AUTOMATED MECHANICAL BRAKE TOUCH UP ENHANCEMENT

(71) Applicant: Caterpillar Inc., Deerfield, IL (US)

(72) Inventors: Brian D. Kuras, East Peoria, IL (US); Ankit Sharma, Peoria, IL (US); Jeremy Peterson, Washington, IL (US)

(73) Assignee: Caterpillar Inc., Deerfield, IL (US)

(21) Appl. No.: 16/278,593

(22) Filed: Feb. 18, 2019

(51) Int. Cl. B60T 8/58; B60T 8/50; B60T 8/171; B60T 13/68; B60T 13/12

(52) U.S. Cl. CPC B60T 8/58; B60T 8/50; B60T 13/12; B60T 13/686; B60T 8/171

(57) ABSTRACT

A work machine with a mechanical brake touch-up system includes a power source that provides power to a rotational element. The work machine includes a brake that is configured with a piston to selectively engage a frictional element rotationally coupled to the rotational element, a position sensor for generating a position signal of the piston, and a control valve configured to supply hydraulic pressure to the piston to selectively apply a retarding torque to the frictional element, a speed sensor for generating a rotational speed signal. The work machine includes a touch-up controller which is configured to detect a retarding condition of the work machine based on the speed signal, and, upon detection of a retarding condition, control the position of the piston to a touch-up position between an engaged and retracted position.

### TECHNICAL FIELD

The present disclosure generally relates to the control of a work machine braking system and, more particularly, to a method and system for electronic control of a braking system in machines equipped with friction braking systems.

### BACKGROUND

Many work machines are equipped with various types of transmissions for coupling the output of a prime mover or power source, for example, an internal combustion engine, to a driven element or device such as the wheels or a work implement on the work machine. Types of transmissions include traditional geared transmission, continuously variable transmissions (CVT), infinitely variable transmissions (IVT), and the like. In some machines, the transmission may function to transmit a retarding power back to the prime mover to slow or limit the machine's propulsion. The retarding power is power obtained from the machine's driven elements and directed back to the power source. Retarding power can be generated while travelling down a decline, coasting, downshift, or any other unwanted speed condition.

To mitigate an unwanted speed condition, the operator typically commands a service brake or an engine brake to reduce the wheel speed and aid in retarding the work machine. However, there is an inherent initial delay in the braking system before it is capable of producing a braking torque. The initial delay is small enough that during normal operation, an operator naturally compensates for the initial delay by how quickly they call for the brakes to retard the work machine. In certain situations, the initial delay is large enough to reduce performance and may even cause instabilities in feedback control loops designed to command the brakes without operator input.

One method for retarding a power source is described in U.S. Patent Publication No. 2017/0067228 A1 (the '228 publication), titled “System For Applying Brake Torque on Wheel of Machine” and assigned to the assignee of the present application. The '102 publication describes a method reducing the distance to halt a machine by monitoring the brake pedal position and comparing a desired fluid pressure corresponding with a detected brake pedal position to an actual fluid pressure supplied to the calipers. However, the methodology in the '228 publication fails to disclose a braking control system which compensates for the initial delay in a retarding condition.

The disclosed system and method directed to overcoming one or more of the problems set forth above.

### SUMMARY OF THE DISCLOSURE

In accordance with one aspect of the disclosure, a braking system with a touch-up controller is provided. The braking system includes a speed a speed sensor configured to generate a speed signal. The system includes a brake disc which is rotationally coupled to a driven element. A service brake is configured with a piston to selectively engage and disengage the brake disc. A position sensor generates and transmits a position signal associated with a position of the piston. A control valve is in fluid communication with the service brake. The control valve is configured to supply hydraulic pressure to control the operation of the piston to selectively apply the retarding torque to the brake disc. The system also includes a touch-up controller which is in electronic communication with the position sensor and the control valve. The touch-up controller is configured detect a retarding condition based on the speed signal, and, upon detection of the retarding condition, transmit a touch-up signal to the control valve to supply hydraulic pressure to the service brake until a touch-up condition is achieved. The touch-up condition includes controlling the position of the piston to a touch-up position between an engaged position and a retracted position.

In accordance with another aspect of the disclosure, a work machine with a touch-up controller is provided. The work machine includes a power source that is configured to provide power to a rotational element; a frictional element that is rotationally coupled to the rotational element; a speed sensor that is configured to generate a speed signal associated with a rotational speed; a brake that is configured with a piston to selectively engage and disengage the frictional element; a position sensor that generates a position signal associated with a position of the piston; and a control valve which is in fluid communication with the service brake. The control valve is configured to supply hydraulic pressure to control the operation of the piston to selectively apply a retarding torque to the brake disc. The work machine also includes a touch-up controller which is in electronic communication with the speed sensor, position sensor, and the control valve. The touch-up controller is configured to detect a retarding condition of the work machine based on the speed signal, and, upon detection of a retarding condition, transmit a touch-up signal to the control valve to supply hydraulic pressure to the service brake until a touch-up condition is achieved. The touch-up condition includes controlling the position of the piston to a touch-up position between an engaged position and a retracted position.

In accordance with a further aspect of the disclosure, a method for mechanical brake touch-up is provided. The method includes generating a rotational output and a rotational speed signal associated with the rotational output; providing the rotational output to a rotational element; generating a position signal associated with a position of a piston of a brake; detecting a retarding condition based on the rotational speed signal; and upon detection of a retarding condition, controlling a supply of hydraulic pressure to a service brake until a touch-up condition is achieved, wherein the touch-up condition includes controlling the position of the piston to a touch-up position between an engaged position and a disengaged position.

### BRIEF DESCRIPTION OF THE DRAWINGS

FIG. 1 is a diagrammatic side view of a wheeled loading machine with a system in accordance with an embodiment of the present disclosure;

FIGS. 2-4 are a schematic views of the braking system with a piston in various positions in accordance with an embodiment of the present disclosure;

FIG. 5 is a flow chart of a sequence in accordance with an embodiment of the present disclosure; and

FIG. 6 is a flow chart of a sequence in accordance with an embodiment of the present disclosure.

### DETAILED DESCRIPTION

Aspects of the disclosure will now be described in detail with reference to the drawings, wherein like reference numbers refer to like elements throughout, unless specified otherwise.

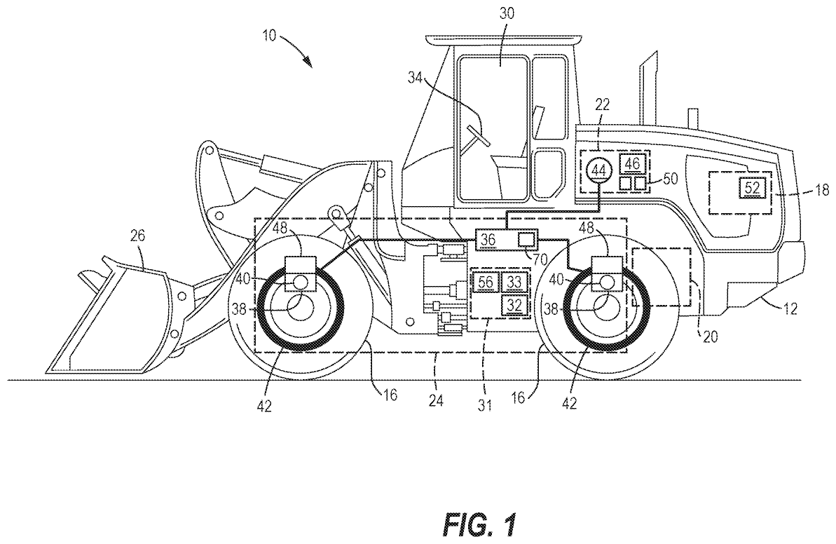

This disclosure relates to a work machine equipped with a piston actuated friction brake such as service brake for applying a braking torque to a driven element or a work machine equipped with a transmission brake for applying a braking torque to an inboard drivetrain element of the power train. Referring to FIG. 1, a side view of a work machine 10, such as a wheeled loader, is illustrated. In various examples, the work machine 10 may be associated with various industries, such as mining, construction, farming transportation, or any other industry known in the art. While a wheel loader is shown, the mechanical brake touch-up strategy discussed herein may be implemented in any other appropriate type of work machine or vehicle either wheeled or track-type, such as trucks, cars, on-highway trucks, dump trucks, off-highway trucks, earth moving machines, track type loaders, compactors, excavators, track type tractors, dozers, motor graders, wheel tractor-scrapers, pavers, or any other work machine known in the art.

The machine 10 includes a frame 12 which supports a machine body 14, with the frame 12 being supported on the ground by a pair of traction devices or driven elements 16. As illustrated, the driven elements 16 include a plurality of wheels 16, but the driven elements 16 could include any other appropriate devices such as an undercarriage with tracks, halftracks, or combinations of tracks, wheels or other traction devices.

The work machine 10 is driven by a power train including a power source 18 operatively connected to a transmission 20 that in turn is operatively connected to the wheels 16. The power source 18, sometimes referred to as a prime mover, may embody a combustion engine, such as a diesel engine, a gasoline engine, a gaseous fuel powered engine (e.g., a natural gas engine), or any other type of combustion engine known in the art. The power source 18 may alternatively embody a non-combustion source of power, such as a fuel cell or a power storage device coupled with an electric motor. The power source 18 provides a rotational output to drive the wheels 16, thereby propelling the machine 10. The power source 18 may also provide a rotational output to provide power to a hydraulic system 22 for actuating various hydraulically driven systems such as a braking system 24, a work implement 26, and the like.

The transmission 20 transfers the rotational output from the power source 18 to the wheels 16 to provide motive power to the work machine 10. The transmission 20 may provide a number of fixed gears, such as in a traditional geared transmission, or may provide a continuous or infinite number of available torque-to-speed ratios for varying the output from the power source 18 such as in a CVT or IVT.

An operator can control the movement of the work machine 10 along with other operations of the work machine 10 at an operator station 30. The controlled operations can include speed control, steering, load dumping, actuation of implements of the work machine 10, and the like. The operator station 30 may have a plurality of operator input devices for inputting commands for the power source 18, the transmission 20 and other systems of the work machine 10. The operator input devices can include engine throttles, brake pedals, gear shift levers, steering wheels, implement lift and articulation controls, graphical user interfaces, and the like. Sensors associated with each of the operator input devices detect manipulation of the operator input devices by an operator and transmit corresponding input device command signals that are received and processed by an electronic control module (ECM) 31.

The ECM 31 may include a processor 32 for executing a specified program, which controls and monitors various functions associated with the work machine 10. The processor 32 may be operatively connected to a memory 33 that may have a read only memory (ROM) for storing programs and a random access memory (RAM) serving as a working memory area for use in executing a program stored in the ROM. The memory 33 as illustrated is integrated into the ECM 31, but those skilled in the art will understand that the memory 33 may be separate from the ECM 31 but onboard the work machine 10, and/or remote from the ECM 31 and the work machine 10, while still being associated with and accessible by the ECM 31 to store information in and retrieve information from the memory 33 as necessary during the operation of the work machine 10. Although the processor 32 is shown, it is also possible and contemplated to use other electronic components such as a microcontroller, an application specific integrated circuit (ASIC) chip, or any other integrated circuit device. While the discussion provided herein relates to the functionality of a braking system, the ECM 31 may be configured to control other aspects of the operation of the work machine 10 such as, for example, steering, dumping loads of material, actuating implements and the like. Moreover, the ECM 31 may refer collectively to multiple control and processing devices across which the functionality of the braking system and other systems of the work machine 10 may be distributed. Such variations in consolidating and distributing the processing of the ECM 31 as described herein are contemplated as having use in braking reduction and transmission control in accordance with the present disclosure.

The work machine 10 includes a braking system 24 for applying a retarding torque during operation of the work machine 10. The retarding torque can be applied to the wheels, as in a service brake, or be applied to drivetrain element of the power train. During normal operation, an operator manually operates the braking system 24 by depressing a brake actuator, such as a brake pedal 34, to generate a pedal position signal which is indicative of the depressed position of the brake pedal 34 relative to a normal position. The brake pedal 34 includes a range of positions between a normal position, or unactuated position, to a fully depressed position, or fully actuated position. The normal position corresponds to a generated minimum braking signal in which no retarding torque is applied to the wheels 16, whereas the fully depressed position corresponds to a generated maximum braking signal where maximum retarding torque is applied to the wheels 16. The operator can also generate a proportional braking signal within a continuous range from the normal position and the fully actuated position. It should be appreciated that the relationship between the pedal position signal and the output braking signal can be proportional, as previously described, or non-linear.

In an exemplary embodiment, the braking system 24 also includes a control valve 36 which is in fluid communication with a brake, such as service brakes 38, each of which are configured with a piston 40 to selectively engage and disengage a frictional element such as a brake disc 42 that is rotationally coupled to each wheel 16. The control valve 36 is in fluid communication with a hydraulic pump 44 and a hydraulic tank 46, of the hydraulic system 22. The control valve 36 selectively controls the flow of pressurized hydraulic fluid into the service brake 38 in order to control the position of the piston 40 between a fully retracted position and a fully engaged position based on a received braking signal from the ECM 31. When the control valve 36 supplies pressured hydraulic fluid to the service brake 38, the piston 40 may be urged toward the brake disc 42 into a fully engaged position in order to apply a retarding torque to the rotating brake disc 42. Alternatively, when the control valve 36 is not supplying pressurized hydraulic fluid to the service brake 38, it is redirecting flow from the service brake to the hydraulic tank 46 during which a biasing spring (not shown) pushes the piston 40 back into the service brake 38 into a fully retracted position. It should be appreciated that the brake system 24 may include an electronically actuated transmission brake, not shown, in place of or in addition to the service brakes 38.

The control valve 36 can be an electrohydraulic valve that is in electronic communication with the ECM 31. The control valve 36 is configured to receive a current signal from the ECM 31. Upon receipt of the current signal, the control valve 36 allows the fluid to pass therethrough based on various parameters, such as an ampere rating of the current signal. A flow rate and a pressure of the fluid flowing through the control valve 36 are controlled based on the current signal received from the ECM 31. For example, in the fully retracted position, wherein the control valve 36 receives a minimum braking signal or no braking signal from the ECM 31, the control valve 36 is instructed to supply no hydraulic pressure or redirect hydraulic fluid away from the service brake 38 to the hydraulic tank 46 and the piston 40 becomes completely disengaged from the brake disc 42 and no rotational torque is applied. In the engaged position, wherein the control valve 36 receives a maximum braking signal from the ECM 31, the control valve 36 is instructed to supply maximum hydraulic pressure to the service brake 38 and the piston 40 becomes fully engaged with the brake disc 42 in order to apply a maximum retarding torque.

The ECM can also generate a current signal within a continuous range between the minimum braking signal and the maximum braking signal. Under this condition, the control valve 36 is instructed to supply hydraulic pressure corresponding to the received current signal between no hydraulic pressure and maximum hydraulic pressure to the service brake 38. This will cause the piston 40 to fully engage with the brake disc 42 but will not cause the service brake 38 to apply the maximum retarding torque. It should be understood that the retarding torque will be proportional to the hydraulic pressure applied to the piston 40. While the piston 40 is fully engaged with the brake disc 42, it may not move relative to the brake disc 42 whether it is receiving a maximum braking torque or any other braking torque greater than zero.

The braking system 24 also includes a position sensor 48 configured to generate and transmit a position signal associated with the position of the piston 40. The position sensor 48 is in electronic communication with the ECM 31 which is configured to receive the generated position signal. The position sensor 48 may include any variety of sensors to generate the position signal associated with the position of the piston 40 relative to the service brake 38. In one embodiment, the position sensor 48 is a pressure sensor disposed on or near the service brake 38 to determine the input pressure of the supplied hydraulic pressure from the control valve 36. The ECM 31 receives the input pressure in the form of the position signal and determines the position of the piston based on the input pressure. The ECM 31 may relate the input pressure to previously stored historical data to determine the position of the piston 40 based on the input pressure. In another embodiment, the position sensor 48 is a displacement sensor disposed on the service brake and/or piston and is configured to generate the position signal according to a relative displacement between the piston 40 and the service brake 38. In another embodiment, the position sensor 48 is a timer configured to generate the position signal according to an elapsed time period associated with the operation of the control valve 36. For example, the ECM 31 may relate measured elapsed times required to achieve a fully engaged position of the piston 40 from a fully retracted position to historical data in order to determine the position of the piston 40. The measured elapsed time is associated with the time during which the control valve 36 is supplying hydraulic pressure to the service brake 38.

The ECM 31 also collects and records operational data relating to the operation of the work machine 10 as it operates within the work site and traverses the work surface. The work machine 10 may include a variety of sensors to automatically monitor various operational data during the operation of the work machine 10 within the work site. For example, the hydraulic system 22 may include a temperature sensor 50 which is configured to generate and transmit a temperature signal associated with the hydraulic fluid temperature to the ECM 31. The ECM may modify or fine-tune the generated position signal based on the oil temperature signal. As hydraulic fluid temperature decreases or gets colder, the viscosity of the hydraulic fluid increases and thus it takes longer to get the hydraulic fluid into and out of the service brake 38. The ECM 31 can compensate for hydraulic fluid temperature when determining the piston position based on the generated position signal.

The ECM 31 also includes a touch-up controller (TUC) 52. The TUC 52 is configured commands the piston 40 to move to a predetermined touch-up position relative to brake disc 42 in order to reduce the delay of a braking command. In one embodiment, the TUC 52 is configured to touch-up the piston 40 in response to any braking signal. In another embodiment, the TUC 52 is configured to detect a retarding condition, an over-speed condition based on a speed sensor 54, or any other unwanted speed condition in order to touch-up the piston 40. The TUC 52 receives a generated speed signal from the speed sensor 54 which is associated with at least one of the rotational speed of the power source 18, the rotational output of the power source 18, the rotational input of the transmission 20, or the rotational output of the transmission 20. The TUC 52 may detect or indicate a retarding condition a number of ways. For example, if the TUC 52 detects a rotational speed of the power source 18 greater than a retarding threshold while the operator has released the throttle or if the TUC 52 detects an increasing rotational speed while the operator has released the throttle. In another embodiment, the TUC 52 may also be configured to detect a retarding condition based on an inclination signal generated by an inclination sensor 56. For example, if the generated inclination signal received by the TUC 52 is greater than an inclination threshold, the TUC 52 may detect or indicate a retarding condition. It should be appreciated that the TUC 52 may compare historical data related to any one of payload weight, rotational speed of the power source 18, ground speed, or other operational signals in order to determine if a retarding condition is present.

In another embodiment, the TUC 52 is configured to detect an unwanted or undesired speed condition which can indicate an impending braking command. For example, if the operator has released the throttle in order to coast the work machine 10 to reduce ground speed, the TUC 52 is configured to detect the coasting condition as an unwanted speed condition and to expect an impending braking command. The TUC 52 may also detect a downshifting condition as an impending braking command. For example, when downshifting, the operator is indicating a desire to reduce the wheel speed of the work machine 10, i.e. to slow down the work machine. A downshifting condition is detected based on the ground speed of the work machine 10 which can be determined based on a wheel speed sensor 54 which determines wheel speed, a navigational sensor which determines changes in navigational position from which ground speed can be derived, or any other know methods for determining the movement speed of the work machine 10.

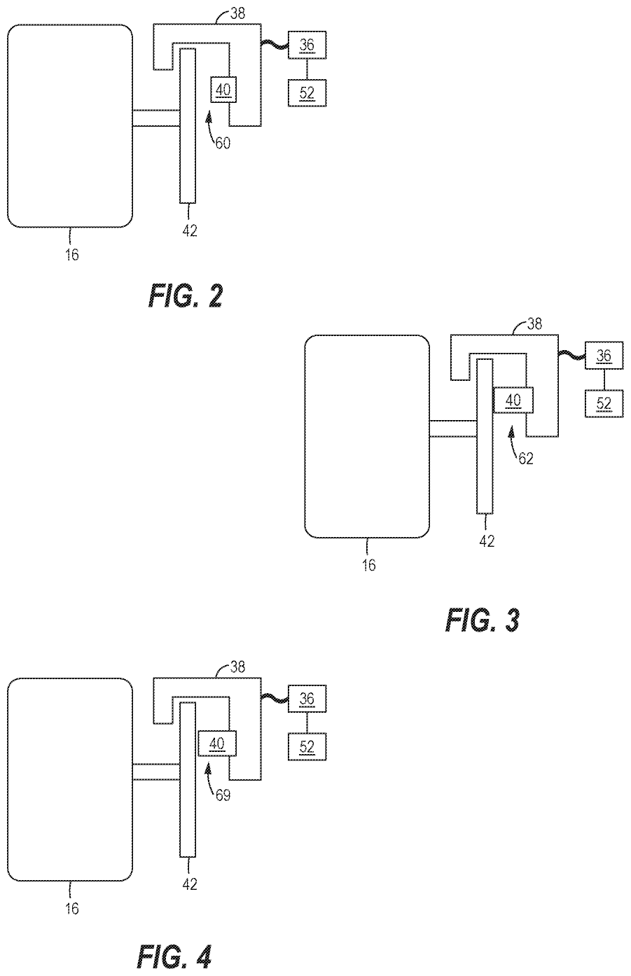

With reference to FIGS. 2-4, a caliper and disc braking mechanism with the piston 40 in several positions relative to the service brake 38 is illustrated. It should be appreciated that other braking systems, such as, but not limited to drum brakes, axle brakes, wet multi-disc brakes, and the like are also contemplated. In FIG. 2, the piston 40 is in a fully retracted position 60 where the piston 40 is at a maximum distance from the disc brake 42. In FIG. 3, the piston 40 is in a fully engaged position 62 where the piston 40 touching the brake disc 42 in order to applying a retarding torque thereupon. It should be appreciated that in the fully engaged position 62, the control valve 36 is receiving a braking signal greater than zero from either the ECM 31, during normal operation, or from the TUC 52, in response to a detected retarding condition, unwanted speed condition, or even in response to a normal braking command. The fully engaged position 62 will be substantially the same for any non-zero braking signal. With reference to FIG. 4, upon detection of a retarding condition, the TUC 52 transmits a touch-up signal to the control valve 36 to supply a maximum hydraulic pressure to the service brake 38 until a touch-up condition is achieved. The touch-up condition includes controlling the position of the piston 40 to a touch-up position 64 which is between the fully engaged position 62 and the fully retracted position 60. In an exemplary embodiment, the touch-up position 64 is directly proximate the fully engaged position 62 without supplying any retarding torque to the brake disc 42. The TUC 52 receives the generated position signal transmitted by the position sensor 48 to determine whether the touch-up condition is achieved. For example, when the received position signal is equivalent to a predetermined touch-up position 64, the TUC 52 instructs the control valve 36 to maintain the touch-up position 64 of the piston 40. The TUC 52 maintains the touch-up position 64 by monitoring the position signal in a closed loop feedback fashion. Once the retarding condition has ceased, the TUC 52 ceases the touch-up signal and the ECM 31 is configured to generate braking signals to control the control valve 36 in response to normal operation.

In order to achieve the fastest possible touch-up position 64, the TUC 52 is configured to generate and transmit the touch-up signal in order to over-command the control valve 36. In other words, the magnitude of the touch-up signal is a maximum braking signal or can be greater than the magnitude of a maximum braking signal. More specifically, the control valve 36 supplies hydraulic fluid to the service brake 38 at a maximum hydraulic pressure or at even higher pressure and/or flow rate in response to a touch-up signal than what is supplied in response to a braking signal. It should be appreciated that a braking signal is generally not a maximum braking signal, but the valve is over-commanded until the touch-up position 64 is achieved as indicated or measured based on the feedback from the position sensor 48.

As previously stated, during a detected retarding condition or unwanted speed condition, the TUC 52 instructs the control valve 36 to maintain the touch-up position 64 until the retarding condition or unwanted speed condition is no longer detected. After which, the ECM 31 is configured to instruct the control valve 36 under normal operating conditions. One example of a retarding condition is an over-speed condition which is determined based on the speed signal generated and transmitted by the speed sensor 54. If the speed signal, during a retarding condition, is greater than a predetermined over-speed threshold, the TUC 52 transmits a maximum braking signal to the control valve 36 which in turn supplies a hydraulic pressure to the service brake 38 until the piston 40 is in the fully engaged position 62. After the piston 40 is at or near the fully engaged position 62, the braking signal returns back to the regular commanded signal determined by the ECM 31, thus producing the retarding torque to the brake disc 42 under normal operation conditions. Since the piston 40 is already in the touch-up position 64, the delay between when the maximum braking signal is transmitted to when the piston 40 is in the fully engaged position 62 is significantly reduced.

The TUC 52 detects an under-speed condition based on a comparison of the speed signal generated and transmitted by the speed sensor 54. If the speed signal, during a retarding condition, is less than a predetermined under-speed threshold, the retarding condition has ceased and the TUC 52 transmits a minimum braking signal to the control valve 36 which in turn redirects the hydraulic pressure away from the service brake 38, to the hydraulic tank 46, until the piston 40 is in the fully retracted position 60 beyond the touch-up position 64. Once the retarding condition has ceased, normal operation of the work machine 10 commences and the ECM regains control of the braking system 24. It follows that the TUC 52 is configured to instruct the control valve 36 to supply hydraulic fluid to the service brake 38 in order to maintain a touch-up position 64 while the detected speed signal is between the over-speed threshold and under-speed threshold during a detected retarding condition.

In another embodiment, the TUC 52 is configured position the piston 40 in a touch up position 64 in response to any braking signal whether or not a retarding condition or unwanted speed condition is detected. The TUC 52 is configured to transmit at least a maximum braking signal to over-command the control valve 36 until the position sensor 48 confirms that the touch-up condition is achieved. The TUC 52 can reduce braking delay during normal operation by over-commanding the control valve 36 to quickly move the piston 40 to the touch up position 64 via a maximum braking signal, then, once the touch-up position 64 is achieved, the ECM 31 then transmits the desired braking signal or regularly commanded braking signal corresponding to the pedal position signal to the control valve 36 to achieve the desired braking torque.

Various work machines 10 utilize a multitude of braking mechanism to slow and stop their respective work machines. As previously stated, these braking mechanism include disc brakes, drum brakes, axle brakes, wet multi-disc brakes, and the like. The braking systems typically rely on a wearable disc or pad (not shown) which provides the friction to apply the retarding torque. Over time, this wearable disc or pad disintegrates from the friction used to brake the work machine and increases the distance the piston 40 has to travel to apply the retarding torque and, in turn, increases the inherent delay of the braking system 24. For example, new brake pads have a delay interval of 0.268 seconds, 50% worn brake pads have a delay interval of 0.475 seconds, while 100% worn brakes a delay interval of 0.710 seconds. The increased travel distance of the piston 40 effects the location of the fully engaged position 62 as well as the touch-up position 64. To determine the location of the fully engaged position 62 and the touch-up position 64, the TUC 52 can be configured to perform a calibration routine. For example, each time the operator starts a work machine 10, the ECM 31 performs a startup routine which includes assessing the various system of the work machine 10 to ensure there are no faults. The startup routine may include instructing the TUC 52 to perform the calibration routine to determine the travel range of the piston 40 from the fully retracted position 60 to the fully engaged position 62. In other words, the difference between the fully retracted position 60 and the fully engaged position 62. From the travel range, the TUC 52 can determine touch-up position which is determined to be directly proximate to the brake disc 42 without producing any significant retarding torque.

### INDUSTRIAL APPLICABILITY

From the foregoing, it may be appreciated that the mechanical brake touch-up system disclosed herein may have applicability in a variety of industries such as, but not limited to, use in work machines or any type of machine which employs a hydraulic braking system with electrohydraulic braking systems. Furthermore, the mechanical brake touch-up system may be used in any industrial system in which closed loop electrohydraulic braking is used as the primary method to retard a rotating assembly in which an inherent delay is present. The present system compensates for the inherent delay by staging the actuator, e.g. piston, adjacent to the braking surface during an expected retarding condition. In other words, by moving a braking piston directly adjacent to without enacting a retarding torque, the system can dramatically reduce the inherent delay of the electromechanical braking system. This results in reduced downtime and maintenance for the work machine by avoiding unwanted over-speed conditions and avoiding unwanted oscillations in the power train. There is the added benefit of increased productivity for the operator of the work machine due reduced operating fatigue resulting from the power train oscillations. Additionally, it is also advantageous that the present mechanical brake touch-up system can be implemented without any modification to preexisting components of the braking system, thereby not endangering the functionality of the braking system with newly introduced components or devices. Having a calibration routine to not only determine the touch-up position but also determine the wear status of the physical components of the braking system would be extremely useful and beneficial to all operators, maintenance technicians and companies owning the work machines. Moreover, the disclosed mechanical brake touch-up system can be employed in any type of industry that facilitates the use work machines. Such industries may include mining, construction, farming, transportation, police and military work machines, recreational off-road machines, rail, agriculture, shipbuilding equipment, drainage and sewer maintenance machines, underwater maintenance machines or any like environment in which a work machine utilizing hydraulic braking may be needed or operated.

During normal operation of a work machine 10, in order to slow down or stop the work machine 10, the operator depresses the brake pedal 34. Upon depressing the brake pedal 34, the ECM 31 receives the generated pedal position signal and transmits a corresponding braking signal proportional to the pedal position signal to the control valve 36 in order to control the flow rate and pressure supplied to the service brake 38. However, in the situation where a retarding condition or unwanted speed condition is detected, the ECM 31 may engage the TUC 52 in order to avoid an over-speed condition which may damage the power source 18 and/or the transmission 20. For example, in a retarding condition, a transmission 20 may redirect the rotational output back to the power source 18. Such as while retarding down a negative grade, the redirected power may cause an over-speed condition, upon which the ECM 31 controls the braking system 24 to aid in retarding the work machine 10 and reducing the engine speed. Due to an inherent delay from commanding the braking system from a fully retracted condition to a fully engaged condition, can cause the ECM to overcompensate the magnitude of the braking signal generated and transmitted to the control valve 36. Due to the closed loop nature of the ECM 31, the generated and transmitted braking signal may cause unwanted oscillations which introduce instabilities in the retarding of the work machine 10 which results in a lack of overall machine productivity and operator fatigue.

In another example, the ECM 31 may engage the TUC 52 during an unwanted speed condition such as when the work machine 10 is coasting, directional shifts, or downshifting. The TUC 52 is configured to detect an unwanted speed condition and aid in the retarding of the work machine 10 by initiating a touch-up condition to reduce the delay of the braking signal associated with the retarding.

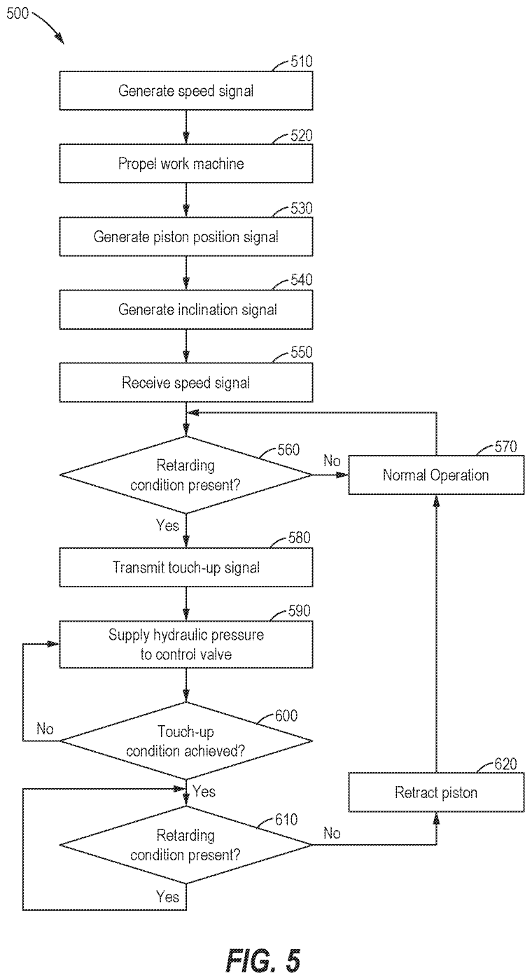

In an exemplary method for mechanical brake touch-up 500 as illustrated in FIG. 5, the power source 18 of the work machine 10 generates a rotational output and the speed sensor 54 generates and transmits a rotational speed signal which corresponds to the rotational speed of the rotational output, as shown in block 510. In block 520, the rotational output is then provided to at least one driven element via a transmission 20 to propel the work machine 10. In block 530, the brake system 24 of the work machine 10 includes the position sensor 48 which is configured to generate and transmit a signal associated with a position of a piston 40 of the service brake 38. In block 540, the ECM 31 may also generate and transmit inclination signal based on an output of the inclination sensor 56. In block 550, the TUC 52, of the ECM 31, is configured to receive at least the rotational speed signal and the piston position signal, but may also receive the inclination signal. In block 560, the TUC 52 detects whether a retarding condition or an unwanted speed condition is present. If no retarding condition or unwanted speed condition is present, the work machine will operate as normal receiving braking signals from the ECM 31 based on the brake pedal 34 position during manual operation, block 570. However, if a retarding or unwanted speed condition is detected, the TUC 52 transmits a touch-up signal to the control valve 36, block 580. Then in block 590, in response to the transmitted touch-up signal, the control valve 36 is instructed to supply at least a maximum flow of hydraulic pressure to the service brake 38. At block 600, the TUC 52 continues to transmit the touch up signal until a touch-up condition is achieved. The touch-up condition includes controlling the position of the piston to the touch-up position 64 between the fully engaged position 62 and the retracted position 60.

Once the touch-up condition is achieved, the TUC 52 is configured to maintain the touch-up position 64 while the detected retarding or unwanted speed condition is present. In block 610, the TUC 52 monitors the received speed signal during the retarding condition or unwanted speed condition to determine if the condition is still present. When the TUC 52 has determined that the retarding condition no longer exists and braking is not desired, the ECM 31 transmits a minimum braking signal to the control valve 36 which in turn redirects the hydraulic pressure away from the service brake 38, to the hydraulic tank 46, until the piston 40 is in the fully retracted position 60 beyond the touch-up position 64, block 620. After which the work machine 10 returns to normal operation and the ECM 31 generates the regularly commanded braking signal, block 570, and the TUC 52 resumes monitoring if a subsequent retarding condition is present, block 560.

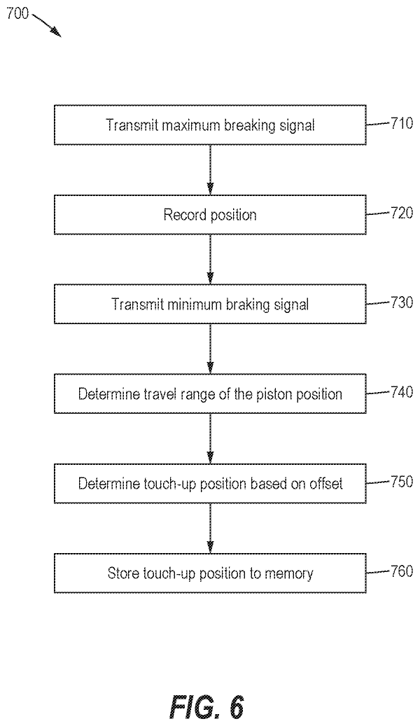

With reference to FIG. 6, a method for determining the touch-up position 700 is presented. In block 710, the TUC 52 transmits a maximum braking signal to the control valve 36 to supply hydraulic fluid to the service brake 38 until the fully engaged position 62 is achieved. The control valve 36 may also include a fluid sensor 70 which is configured to generate and transmit a fluid signal associated with the pressure and/or flow output of the control valve 36 to the service brake 38. The TUC 52 can determine when the piston 40 is in a fully engaged position 62 by monitoring the fluid signal received from the fluid sensor 70 and corresponding position signal from the position sensor 48. If the pressure supplied to the service brake 38 is in a steady state condition, i.e. maximum retarding torque is achieved, then the piston 40 is fully extended. In block 720, the TUC 52 records the position signal associated with the piston 40 in the fully engaged position 62. In block 730, the TUC 52 transmits a minimum braking signal to control valve 36 which then redirects hydraulic pressure away from the service brakes 38 and records the position signal associated with the piston 40 in the fully retracted position 60. The TUC 52 compares the recorded fully retracted position 60 and the fully engaged position 62 to determine a travel range of the piston position, block 740. The TUC 52 then subtracts a predetermined offset from the travel range to determine an optimal touch-up position 64, block 750. The optimal touch-up position 64 is then stored to memory 33 for retrieval by the TUC 52.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. Recitation of ranges of values herein is merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A braking system comprising:
a speed sensor configured to generate a speed signal;
brake disc rotationally coupled to a driven element;
a service brake configured with a piston to selectively engage and disengage the brake disc;
a position sensor for generating a position signal associated with a position of the piston;
a control valve in fluid communication with the service brake, the control valve configured to supply hydraulic pressure to control the operation of the piston to selectively apply a retarding torque to the brake disc;
a touch-up controller in electronic communication with the position sensor and the control valve, the touch-up controller configured to:
detect a retarding condition of the based on the speed signal, and
upon detection of the retarding condition, transmit a touch-up signal to the control valve to supply hydraulic pressure to the service brake until a touch-up condition is achieved, wherein the touch-up condition includes controlling the position of the piston to a touch-up position between an engaged position and a retracted position.

2. The system of claim 1, wherein the touch-up signal over-commands the control valve to supply a maximum hydraulic pressure until the touch-up condition is achieved; and wherein the touch-up position of the piston is directly proximate to the engaged position without applying a retarding torque to the brake disc.

3. The system of claim 1, wherein the service brake includes at least one of a disc brake, a drum brake, an axle brakes, a wet multi-disc brakes, a transmission brake, and an engine brake.

4. The system of claim 1, wherein the touch-up controller is further configured to:
maintain the touch-up position during the retarding condition;
upon cessation of the retarding condition, transmit a disengage signal to the control valve to redirect hydraulic pressure from the service brake until the piston is in the retracted position beyond the touch-up position.

5. The system of claim 1, wherein the touch-up controller is further configured to:
determine a travel range of the of the piston from the engaged position to the retracted position; and
determine the touch-up position according to the determined travel range.

6. A work machine comprising:
a power source configure to provide power to a rotational element;
a frictional element rotationally coupled to the rotational element;
a speed sensor configured to generate a speed signal associated with a rotational speed;
a brake configured with a piston to selectively engage and disengage the frictional element;
a position sensor for generating a position signal associated with a position of the piston;
a control valve in fluid communication with the brake, the control valve configured to supply hydraulic pressure to control the operation of the piston to selectively apply a retarding torque to the frictional element;
a touch-up controller in electronic communication with speed sensor, position sensor, and the control valve, the touch-up controller configured to:
detect a retarding condition of the work machine based on the speed signal, and
upon detection of a retarding condition, transmit a touch-up signal to the control valve to supply hydraulic pressure to the service brake until a touch-up condition is achieved, wherein the touch-up condition includes controlling the position of the piston to a touch-up position between an engaged position and a retracted position.

7. The work machine of claim 6, wherein the touch-up signal over-commands the control valve to supply a maximum hydraulic pressure until the touch-up condition is achieved; and wherein the touch-up position of the piston is directly proximate to the engaged position without applying a retarding torque to the brake disc.

8. The work machine of claim 6, wherein the brake includes at least one of a disc brake, a drum brake, an axle brake, a wet multi-disc brake, a transmission brake, and an engine brake.

9. The work machine of claim 8, wherein the speed sensor is associated with at least one of a rotational speed of the power source, a transmission, a power train element, and a driven element.

10. The work machine of claim 6, wherein the touch-up controller is further configured to:
maintain the touch-up position during the retarding condition;
upon cessation of the retarding condition, transmit a disengage signal to the control valve to redirect hydraulic pressure from the service brake until the piston is in the retracted position beyond the touch-up position.

11. The work machine of claim 10, wherein the retarding condition includes any one of a coasting condition, downshifting condition, and a directional shift.

12. The work machine of claim 6, wherein the touch-up controller is further configured to:
determining a travel range of the piston position from the engaged position to the retracted position based on the corresponding position signal; and
determining the touch-up position according to the determined travel range.

13. The work machine of claim 6, wherein the position sensor includes any one of a displacement sensor configured to generate the position signal according to a relative displacement between the piston and frictional element; a pressure sensor configured to generate the position signal according to the hydraulic pressure at the service brake; and a timer configured to generate the position signal according to a time length associated with the operation of the control valve.

14. The work machine of claim 6, wherein the supply of hydraulic pressure to the service brake during the touch-up condition is greater than maximum supply of hydraulic pressure to service brake during normal operation.

15. A method for mechanical brake touch-up, the method comprising:
generating a rotational output;
providing the rotational output to a rotational element;
generating a rotational speed signal associated with a rotational speed;
generating a position signal associated with a position of a piston of a brake;
detecting a retarding condition based on the rotational speed signal; and
upon detection of a retarding condition, controlling a supply of hydraulic pressure to brake until a touch-up condition is achieved, wherein the touch-up condition includes controlling the position of the piston to a touch-up position between an engaged position and a disengaged position.

16. The method of claim 15, wherein the touch-up signal over-commands the control valve to supply a maximum hydraulic pressure until the touch-up condition is achieved; and wherein the touch-up position of the piston is directly proximate to the engaged position without applying a retarding torque to the brake disc.

17. The method of claim 15, wherein the brake includes at least one of a disc brake, a drum brake, an axle brake, a wet multi-disc brake, a transmission brake, and an engine brake.

18. The method of claim 15, further including:
maintaining the touch-up position during the retarding condition;
upon cessation of the retarding condition, redirecting hydraulic pressure from the brake until the piston is in a retracted position beyond the touch-up position.

19. The method according to claim 15, further including:
determining a travel range of the piston position from the engaged position to the retracted position based on a corresponding piston position signal; and
determining the touch-up position according to the determined travel range.

20. The method according to claim 15, wherein generated position signal is based on at least one of a relative displacement between the piston and frictional element; a hydraulic pressure at the service brake; and a time length associated with the operation of the control valve.
